(19) United States
(12) Patent Application Publication
(10) Pub. No.: US 2007/0156974 A1
(43) Pub. Date: Jul. 5, 2007

(54) Managing internet small computer systems interface communications

(76) Inventors: John E. Haynes JR., South Weymouth, MA (US); Donald C. Wiser, Sutton, MA (US); William R. Sears, North Attleboro, MA (US); Adam J. Hutchinson, Templeton, MA (US); Marc Pilon, Fitchburg, MA (US)

Correspondence Address: RICHARD M. SHARKANSKY, PO BOX 557, MASHPEE, MA, 02649, US

(21) Appl. No.: 11/324,963

(22) Filed: Jan. 3, 2006

(51) Int. Cl. G06F 13/28

(52) U.S. Cl. 711/147

(57) ABSTRACT

A system for use in managing internet Small Computer Systems Interface (iSCSI) communications includes core logic and application programming interface (API) logic. The core logic has iSCSI protocol processing capability and is hardware independent for iSCSI communications. The system API logic is hardware dependent for iSCSI communications and communicates with the core logic.

### BACKGROUND

This application relates to managing internet Small Computer System Interface (iSCSI) communications.

Computer systems may include different resources used by one or more host processors. Resources and host processors in a computer system may be interconnected by one or more communication connections. These resources may include, for example, data storage systems, such as the Symmetrix™ and Clariion families of data storage systems manufactured by EMC Corporation. These data storage systems may be coupled to one or more host processors and provide storage services to each host processor. An example data storage system may include one or more data storage devices, such as those of the Clariion family, that are connected together and may be used to provide common data storage for one or more host processors in a computer system.

A host processor may perform a variety of data processing tasks and operations using the data storage system. For example, a host processor may perform basic system I/O operations in connection with data requests such as data read and write operations. Host processor systems may store and retrieve data using a storage device containing a plurality of host interface units, disk drives, and disk interface units. Such storage devices are provided, for example, by EMC Corporation of Hopkinton, Mass. and disclosed in U.S. Pat. No. 5,206,939 to Yanai et al., U.S. Pat. No. 5,778,394 to Galtzur et al., U.S. Pat. No. 5,845,147 to Vishlitzky et al., and U.S. Pat. No. 5,857,208 to Ofek. The host systems access the storage device through a plurality of channels provided therewith. Host systems provide data and access control information through the channels to the storage device and storage device provides data to the host systems also through the channels. The host systems do not address the disk drives of the storage device directly, but rather, access what appears to the host systems as a plurality of logical disk units. The logical disk units neither may or may nor correspond to the actual disk drives. Allowing multiple host systems to access the single storage device unit allows the host systems to share data stored therein.

For interconnection and communication with host systems, a data storage system may use one or more types of communications systems, such as Fibre Channel protocol or the internet Small Computer System Interface (iSCSI) protocol, which is based on Small Computer System Interface (SCSI) and Transmission Control Protocol (TCP) protocols which are well known within the art of computer science

In brief, SCSI is a standard specifying the interface between devices that were originally controllers and peripherals in computer systems. The SCSI architecture is a client-server architecture wherein clients and servers are called “initiators” and “targets,” respectively. Initiators send service requests to targets and receive responses from targets.

A target is a collection of logical units. Each logical unit contains a device server, one or more task sets (queues), and a task manager.

SCSI recognizes two types of requests: device-server requests and task-management requests. The device server processes the device-server commands while the task manager is responsible for task management.

A device-server request is a SCSI command for execution on a logical unit, such as a block read/write command. Each device-server request defines a unit of work for a logical unit. Within a logical unit, a task represents a unit of work.

A SCSI task is an execution context a target creates for a SCSI command or a series of linked SCSI commands. A new task is created for each single command, while the same task is used for all the commands in a series of linked commands, also referred to as a “chain of commands.” A task persists until a command (or a series of linked commands) completion response is sent or until the task is ended by a task management function or exception condition. The initiator sends the next linked command in a series of linked commands only after the current command completes. That is, only one pending command exists per task. From the initiator's point of view, the device server is not multi-tasking; a task executes until it completes. This property allows initiators to implement, for example, read-modify-write commands using linked commands.

Task management requests control the execution of tasks. Examples of task management requests include aborting a task, clearing an exception condition and resetting a logical unit. The task manager manages task queues and serves task management requests.

Both initiators and targets have ports to communicate with their counterparts. The requests and responses are sent through and received from these ports. An initiator or target has one or more ports. Each port has a unique identifier. Each request includes its initiator and target port identifiers. These identifiers are in a “nexus object” in the request. In addition, the nexus object optionally contains an identifier for the logical unit and the task. The logical unit identifier is included if the request is destined for a particular logical unit. Similarly, the task identifier is included if the request is for a specified task.

SCSI is described more fully in the SCSI-3 Architecture Model (SAM), available at www.ansi.org as ANSI X3.270-1996, in the SCSI Architecture Model-2 (SAM-2), available at ftp://ftp.t10.org/t10/drafts/sam2/sam2r22.pdf, and in the references mentioned therein.

The TCP/IP suite of protocols forms the basis for the Internet and includes, among other things, the Transport Control Protocol (TCP) and Internet Protocol (IP). Networking protocols are built up in the layers, each being responsible for some distinct aspect of communication. TCP/IP is a four-layer system spanning the upper six layers of the well known seven layer Open System Interconnect OSI networking model. A general description of these protocol layers can be found in the book by W. Richard Stevens entitled TCP/IP Illustrated, Volume 1 (13^{th} printing, 1999).

A data link layer handles the logical interface to the interconnect (e.g., cable) and is where arbitration for network access occurs. Most local area networks use Gigabit Ethernet and are switch based and achieve high bandwidth utilization levels. Addressing at the data link layer is called a “MAC” address or hardware address. This address is assigned at the factory and is unique to each network node.

A network layer is for handling the movement of packets around larger networks. Network layer addressing (IP Address) is an abstraction of the MAC address and simplifies the routing of traffic through the network. This routing simplification enables more efficient routing, worldwide addressability and independence from data link layers. The network layer is also responsible for cutting up frames (fragmentation) and putting them back together (reassembly) if there are links in the path that only support small frames.

A transport layer deals with the flow of data between systems. There are two major protocols used at this layer that provide different services: transport control protocol (TCP) and user datagram protocol (UDP). TCP is a complex protocol that guarantees the delivery of data, in order, to the application layer. In addition, TCP also includes aspects that are administrative in nature, setting up connections between systems, for instance. For example, in Microsoft Windows NT, a transport protocol driver is a software component that implements a transport driver interface (TDI), or possibly another application-specific interface at its upper edge, to provide services to users of the network. Transport protocols act as data organizers for the network, essentially defining how data should be presented to the next receiving layer and packaging the data accordingly. They allocate packets, copy data from the sending application into the packets, and send the packets to the lower level device driver by calling Network Driver Interface Specification (NDIS, described below), so that the data can be sent out onto the network via the corresponding NIC. The packets are sometimes referred to in the Windows NT context as NDIS packets.

Typically, a new peripheral device, a new class of peripheral devices, a new processing card or a new type of processor is integrated into a communications system with drivers that provide code necessary to send commands to and receive replies or data directly from the operating system. Much of the code necessary for integration duplicates older code written for other devices, classes, cards or processors. This duplication may even extend across code for devices, classes, cards and processors, particularly if the code is designed to access commonly used features of an operating system or software module.

One example of an attempt to deal with this issue is the Network Driver Interface Specification (NDIS) written by Microsoft. NDIS defines a common software module interface for a network protocol stack which provides for network communications, adapter drivers which provide media access control (MAC), and protocol managers which enable the protocol stack and the MAC to cooperate. NDIS allows Microsoft Windows modules, which implement different connectionless protocol stacks such as TCP/IP and IPX/SPX, to access different network hardware types such as Ethernet and token ring in a uniform manner. NDIS enables these functions by implementing a NDIS miniport interface.

TCP Chimney provides a method to offload a network stack connection, such as a TCP based protocol stack. Data that would normally be sent through an NDIS path that has multiple software layers to a peripheral device is offloaded to a path from a switch layer to the peripheral device. Tight synchronization with the network stack and processing unit is maintained. A request to offload the stack is sent through the NDIS path to the peripheral device. The request includes a list of resource requirements so that the peripheral device has the information needed to allocate resources. Each layer in the NDIS path adds its resource requirements to the list. If the peripheral device accepts the request, the peripheral device allocates resources and sends an offload handle to each of the software layers so that the software layers can communicate with the peripheral device.

At an application layer, the iSCSI protocol maps the SCSI remote procedure invocation model over the TCP protocol. iSCSI requests carry SCSI commands, and iSCSI responses carry SCSI responses and status. iSCSI also uses the request-response mechanism for iSCSI protocol mechanisms. iSCSI is described more fully in iSCSI, available at http:Hsearch.ietf.org/internet-drafts/draft-ietf-ips-iscsi-11.txt, and in the references mentioned therein.

With the advent of iSCSI, data storage systems may be linked to facilitate the formation of Storage Area Networks (SANs) having increased capabilities and improved performance. SANs that include servers and data storage devices may be interconnected over longer distances, e.g. over IP networks, such as the Internet. For example, iSCSI may be supported over physical media that supports TCP/IP as a transport, and iSCSI implementations may be on Gigabit Ethernet.

iSCSI, more particularly, comprises the rules and processes to transmit and receive block storage applications over TCP/IP networks, and particularly the iSCSI protocol enables SCSI commands to be encapsulated in TCP/IP packets and delivered over IP networks. Thus, implementing SCSI commands over IP networks may be used to facilitate block-level data transfers over Intranets, local area networks (LANs), wide area networks (WANs), the Internet, and the like, and can enable location-independent data storage and retrieval, e.g., at remote workstations or devices.

Each iSCSI device (target or initiator) is allocated a unique name and address. There are two standards which can be employed for iSCSI device naming; EUI (Enterprise Unique Identifier) or IQN (iSCSI Qualified Name). A fully qualified IQN includes the iSCSI target's name and an identifier for the shared iSCSI node or logical volume (“LUN”).

For an initiator to transmit information to a target, the initiator must first establish a session with the target through an iSCSI logon process. This process starts the TCP/IP connection, verifies that the initiator has access to the target (if optional authentication is used), and allows negotiation of various parameters (optionally including the type of security protocol to be used), and the maximum data packet size. The well known TCP port for iSCSI traffic is 3260. If the logon is successful, an ID is assigned to both initiator (an initiator session ID, or ISID) and target (a target session ID or a Target Session Identifying Handle (TSIH)). Thereafter, the full feature phase—which allows for reading and writing of data—can begin. Multiple TCP connections can be established between each initiator target pair, allowing unrelated transactions during one session. Sessions between the initiator and its storage devices generally remain open, but logging out is available as an option.

Command Data Blocks (CDB) are the data structures used to contain the command parameters to be handed by an initiator to a target. The CDB content and structure is defined by device-type specific SCSI standards. The iSCSI protocol is a mapping of the SCSI remote procedure invocation model on top of the TCP protocol. In keeping with similar protocols, the initiator and target divide their communications into messages. The term “iSCSI protocol data unit” (iSCSI PDU) refers to these messages.

An iSCSI network packet includes a transport packet that has payload data which includes one or more PDUs, each of which has an iSCSI header segments, an optional iSCSI header digest comprising a CRC code for use in error checking the iSCSI header segment, an optional iSCSI data segment, and an optional iSCSI data digest comprising a CRC code for use in error checking the iSCSI data segment.

Since iSCSI operates in the Internet environment, security can be important. The iSCSI protocol specifies optional use of IP security (IPsec) to help ensure that the communicating end points (initiator and target) are authentic, the transferred data has been secured through encryption and is thus kept confidential, data integrity is maintained without modification by a third party, and data is not processed more than once, even if it has been received multiple times. The iSCSI protocol also specifies that Challenge Handshake Authentication Protocol (CHAP) be implemented to further authenticate end node identities.

Managing communications for a computer system such as an iSCSI host computer system or an iSCSI based data storage system can be a complicated process and can be handled in any of multiple different ways, including by using any different combinations of hardware, firmware, and/or software.

The iSCSI protocol with the TCP/IP protocol stack running in software requires a large amount of computing power. Some hardware solutions offload the TCP stack processing to a firmware/hardware/state machine based system (or TCP Offload Engine (“TOE”) Adapter).

For example, an implementation that has a software iSCSI driver and a standard network interface card (NIC) may require that the SCSI port to operating system interface, iSCSI processing, TCP/IP processing, and adapter driver be implemented in software that is executed by the host computer's CPU, and that Ethernet processing and the media interface be handled by the adapter (e.g., using an ASIC). A software iSCSI with partial TCP offload solution may require that the host CPU handle the SCSI port to operating system interface, iSCSI processing, and some TCP/IP processing, with the adapter handling Ethernet processing, and the media interface (e.g., using an ASIC). A firmware TCP and firmware iSCSI offload implementation may require that the host CPU handle the SCSI port to operating system interface, with the adapter having firmware or software handling iSCSI processing and TCP/IP processing and an ASIC handling Ethernet processing and the media interface. A hardware TCP and firmware iSCSI offload implementation may require that the host CPU handle the SCSI port to operating system interface, with the adapter having firmware or software handling some iSCSI processing and some TCP/IP processing and an ASIC handling some iSCSI processing, some TCP/IP processing, Ethernet processing, and the media interface. For example, assists may be provided to reduce the burden on the host CPU. Assists may include splitting a header and payload, header parsing, hashing, posting queues, large send offload, and checksum offload (e.g., for use with the iSCSI digests described above).

A host computer system may rely on a Microsoft iSCSI initiator software package that runs on various Microsoft Windows operating systems. The package includes several software components, including Microsoft Initiator and Microsoft Initiator Service. Microsoft Initiator is an iSCSI device driver component that is responsible for moving data from a storage stack to a standard network stack. Microsoft Initiator is used only when iSCSI traffic goes over standard network adapters (also referred to as network interface cards, or NICs), not when specialized iSCSI adapters are used. Microsoft Initiator Service is a service that manages all iSCSI initiators (including network adapters and host bus adapters (HBAs)) on behalf of the operating system. Its functions include aggregating discovery information and managing security. It includes an iSNS client, including functionality used for device discovery.

Microsoft Initiator, in accordance with iSCSI standards, uses Ipsec for encryption and CHAP for authentication.

Microsoft Initiator Service has a common application programming interface (API) that can be used for configuring both Microsoft Initiator and iSCSI HBAs.

A data storage system may rely on an iSCSI controller such as ISP4010 available from QLogic Corporation, Aliso Viejo, Calif. The ISP4010 (also referred to herein as “4010”) is a bus master, single chip, iSCSI controller and TCP offload engine (TOE) for storage and networking applications. The ISP4010 is a mix of hardware state machines and embedded processors. The bulk data movement functions of TCP/IP are executed in hardware, and embedded processors are used for iSCSI, TCP connection establishment/teardown, and other functions. By supporting SCSI, TCP, IP, and Ethernet interfaces, the ISP4010 can support storage area network (SAN) and local area network (LAN) applications. The ISP4010 can minimize host CPU loads by handling complete I/O transactions without host intervention. Embedded processors can control the chip interfaces; execute simultaneous, multiple I/O control blocks (IOCBs); and maintain the required thread information for each transfer. The ISP4010 has a session mode interface and a connection mode interface. In the case of the session mode interface, the ISP4010 is responsible for handling session and connection management, and processing of virtually all the iSCSI protocol. In the case of the connection mode interface, the ISP4010 provides no support for session and connection management, and provides only iSCSI assists for supporting SCSI operations. Thus, the connection mode interface leaves the driver responsible for all session mode management in addition to some or all connection mode management.

In an iSCSI controller such as the ISP4010 the Ethernet data link layer and the network layer may be implemented as hardware logic. iSCSI is dependent on TCP for its transport, and these bulk data movement features of TCP may be implemented in the iSCSI controller as hardware logic. Administrative aspects of TCP that do not affect the data flow performance may be implemented in firmware that runs in iSCSI controller embedded processors.

One or more software drivers is used to allow the data storage system to communicate with the iSCSI controller. These may be referred to as low level programs. Low level programs usually work directly with the interface specific to a given hardware device. While such low level programs tend to offer the programmer substantially complete control over the hardware device, these programs are highly hardware dependent. They do not isolate the specifics of a particular hardware device from the bulk of the system and do not simplify the task of adapting the system to different types of hardware devices.

### SUMMARY OF THE INVENTION

A system for use in managing internet Small Computer Systems Interface (iSCSI) communications includes core logic and application programming interface (API) logic. The core logic has iSCSI protocol processing capability and is hardware independent for iSCSI communications. The system API logic is hardware dependent for iSCSI communications and communicates with the core logic.

One or more implementations of the invention may provide one or more of the following advantages.

A flexible iSCSI implementation can be provided that is less dependent on specific devices and their interface. A system using iSCSI can be adapted quickly to use second sourced components or less expensive components. With little or no modification, system software can be used with a different iSCSI implementation. Different market segments can be addressed with different iSCSI solution without excessive changes to other parts of the system. In particular, the system can use different amounts of offload capability in hardware, including little or no offload, and nearly full offload. A flexible API architecture can be provided that allows different hardware to be used with the same iSCSI core software.

Other advantages and features will become apparent from the following description, including the drawings, and from the claims.

### BRIEF DESCRIPTION OF THE DRAWINGS

FIG. 1 is an illustration of a networked data storage system.

FIG. 2 is an illustration of multiple implementations of an iSCSI driver.

FIG. 3-6 are illustrations of communications using an iSCSI driver.

### DETAILED DESCRIPTION

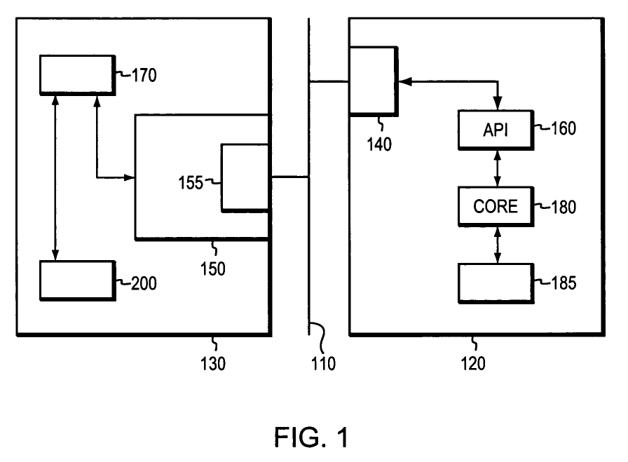

FIG. 1 illustrates a computer system 100 in which a network 110 connects a data storage system (“array”) 120 (e.g., an EMC Clariion AX100) to a server (host) 130. The data storage system has at least one network interface adapter 140 and the server has a network interface adapter 150 that includes at least one network port 155. As described below, the storage system has application programming interface (API) 160 communicating with adapter 140, and iSCSI core 180 communicating between the API and other functionality 185 in the storage system. Adapter 140, API 160, and core 180 provide iSCSI functionality at the storage system.

In a specific implementation, the server runs software 170 (e.g., Microsoft Initiator) that uses interface 150 to provide iSCSI functionality at the server and that communicates between interface 150 and with other functionality 200 in the server.

Server functionality 200 (e.g., database software) communicates with storage system functionality 185 (e.g., data storage components) over network 110 via the iSCSI functionality at the storage system.

API 160 and core 180 form key parts of a Hybrid driver to provide iSCSI access in the storage system. The Hybrid driver may handle most if not all of the iSCSI protocol processing, depending on the implementation, and facilitates adaptation to varying hardware and software requirements, such as supporting hardware offload logic provided by different vendors, or supporting standard software interfaces such as the Microsoft TCP Chimney driver or the standard Microsoft TCP/IP stack.

Core 180 is flexible and is able to function with different types of APIs 160 that pertain to different types of adapters 140 with different levels of offload capability.

An “assisted API” is an API that provides at least some iSCSI offload assist (e.g., an API that can offload iSCSI Digests or iSCSI Data Phases). This offload assist may be provided in the form of an iSCSI offload engine and may not be coded within the API itself. The API serves as a conduit to make use of the offload capabilities of the iSCSI offload engine. An API for a TCP/IP offload engine (TOE) is not an “assisted API” as used herein. An “unassisted API” interfaces to anything from a standard operating system Sockets library to a proprietary TCP/IP offload solution and provides no iSCSI assists.

Each API 160 has an interface to core 180 that allows the core to effectively take advantage of any iSCSI offload capabilities that might be available.

In at least some cases, core 180 handles most if not all of the iSCSI protocol processing. For example, the core may support a QLogic hardware offload device with firmware running in connection mode.

The Core architecture is extensible and portable, and does not preclude adding support for new functionality and other vendor hardware offload devices as may become desirable. In particular, support for error recovery levels 1 and 2, and TDI is not precluded.

In a specific implementation, the Core architecture may be based on the Microsoft Miniport driver model as implemented with standard session mode drivers. In the case of supporting the Microsoft TDI interface and associated TCP/IP stack, the core runs as a Microsoft port driver.

Minimal iSCSI functionality may be provided by the API so as to facilitate portability and allowing as much iSCSI protocol handling as possible to be provided in the core, e.g., support for dual mode (initiator and target) and iSCSI immediate data.

In a specific implementation, the core includes multiple iSCSI core modules that implement the iSCSI protocol, and the driver uses interfaces to the Microsoft operating system, Flare transport driver and layered drivers, the network stack, and hardware offload devices. The modules include the following:

An Initialization Manager (INM) manages and controls initialization for all the modules.

A Session Manager (SSN) manages and maintains context for iSCSI sessions.

A Connection Manager (CXM) manages and maintains context for iSCSI connections.

A Topology Manager (TPM) manages link events.

An Exchange Manager (EXM) manages and maintains context for iSCSI 10 operations.

An Operating System Wrapper (OSW) API implements a multi-protocol dual mode driver interface supporting the operating system, TCD and layered drivers. API 160 implements the hardware offload or software interface to which the core is attached.

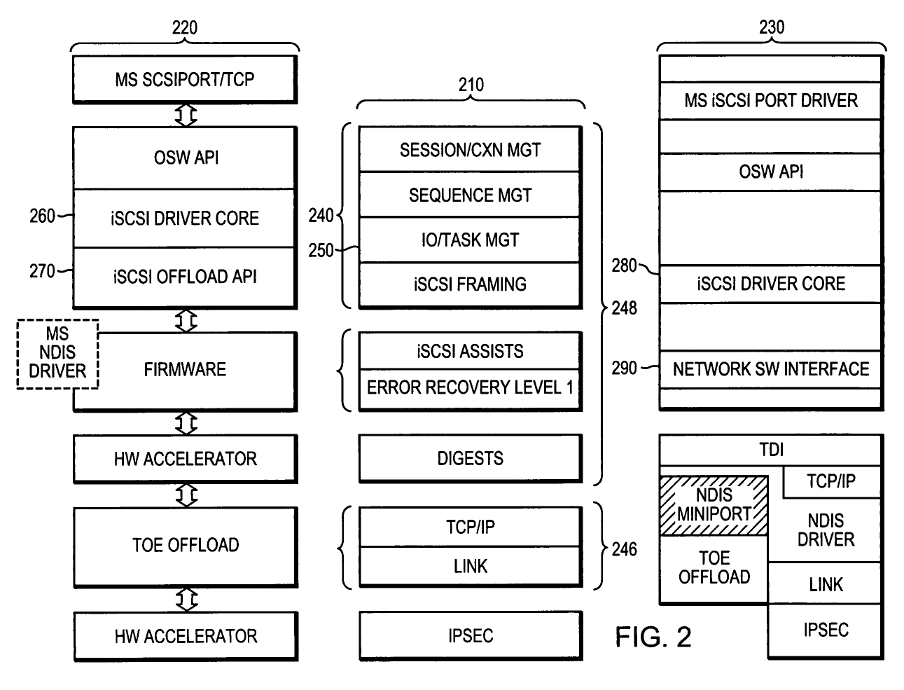

FIG. 2 illustrates three sample implementations in which versions of the API and the portable and extensible core may be used.

Middle column 210 illustrates a full iSCSI with TOE offload implementation, e.g., using the 4010. Left column 220 illustrates a partial iSCSI hybrid with TOE offload, e.g., using a QLogic ISP4022/4032 iSCSI controller or the 4010 in connection mode. Right column 230 illustrates a no offload implementation with support for Microsoft TCP Chimney.

The middle column shows key modules that make up the iSCSI implementation, from the iSCSI driver down to the hardware level at IPsec. As described below, brackets 240, 246, 248 help illustrate where common functionality resides in the different implementations.

From bottom to top, the middle column shows that its implementation has almost all functionality provided in hardware or firmware, e.g., in the 4010 using its session mode interface, and is highly dependent on such hardware and/or firmware. IPsec, TCP/IP, and link level functionality are provided in hardware (e.g. a TOE ASIC), covering the link, transport, and IP layers of the OSI model. In addition, iSCSI digests are handled in hardware. iSCSI assists and error recovery (e.g., level 0 or 1) are handled in firmware or a combination of hardware and firmware.

Session and connection management, sequence management, and iSCSI framing are handled in firmware, with I/O task management processing 250 being handled in software. In this implementation, processing 250 constitutes core 180 and API 160 (e.g., core 180 and API 160A as described below).

From bottom to top, the left column shows that its implementation has lesser use of firmware and/or hardware, which may be or include the 4010 in connection mode. The hardware provides a TOE for TCP/IP and offload and hardware acceleration (digests and some iSCSI assists).

Core 260 may constitute core 180 and API 270 may constitute API 160.

Software handles communication between core 260 and the operating system including, for example, a Microsoft SCSIport/TCD driver.

Core 260 includes all of the functionality indicated by bracket 240. API 270 is used to link core 260 to the firmware or hardware (e.g., iSCSI controller).

In the event different firmware or hardware is used, API 270 is replaced by another API that works with the different firmware or hardware.

Core 260 handles all iSCSI functionality except for some iSCSI assists which are offloaded.

The left and middle column implementations also have an NDIS driver for non-iSCSI network traffic, for connection up to the Microsoft software stack. iSCSI I/O is processed through the TOE, with all other non-iSCSI network traffic going through the Microsoft software stack.

In a specific implementation, the firmware has a filter that traps port addresses for 3260, such that anything that is not iSCSI is redirected to the NDIS driver. Note that 3260 is only a default port address, and a user may select any port address desired.

In the case of offload capability two stacks are provided: the software stack that comes with the operating system kernal, and offloaded version of the stack which corresponds to the TOE. Thus the NDIS driver handles all traffic that is not for iSCSI.

The right column implementation is an example of a TCP Chimney solution, also referred to as an “all software” implementation. At the bottom, the right column shows two types of Microsoft industry standard functionality—rightmost is a well known industry standard “dumb NIC” solution, and the left side of the bottom of the right column illustrates a TOE solution (for TCP/IP).

In the event of use of the Chimney architecture, the vendor provides the NDIS miniport driver which fits into the Microsoft stack along with other modules as shown.

At the very bottom on the right side, a software implementation of IPsec is provided. Moving upward, a link physical connection is provided, as well as an NDIS driver and TCP/IP functionality which fits in as described above. The TDI presents an interface to the application level. Bracket 246 illustrates that the TOE, if used, handles TCP/IP and link functionality.

With respect to TDI, after the NDIS miniport driver is installed, TDI determines (e.g., from a miniport bit setting) which path to use, i.e., the path through the NDIS miniport to the TOE or the path through the software TCP/IP.

Core 280 may constitute core 180 and API 290 may constitute API 160. Core 280 and API 290 can work with both the TOE solution and the dumb NIC solution.

As shown by bracket 248, core 280 includes all of the functionality shown in the middle column above TCP/IP, including session and sequence management, digest processing and iSCSI assists, so that such functionality is performed in software in core 280.

In terms of hardware cost, the dumb NIC implementation is the least costly, the middle column implementation is the most costly, and the TOE version of the right column implementation and the left column implementation are of intermediate cost.

Thus the left and right columns illustrate different ways of using the core (cores 260, 280 may include the same functionality but are used differently). In the left column, API 270 connects to the iSCSI controller, e.g., using connection mode.

With respect to the interfaces at the tops of the left and right columns, the left column provides The left column provides a SCSIPort miniport driver, and the right column provides an iSCSI port driver. Alternatively, using the port driver with the left column implementation in place of the SCSIport miniport driver may provide a more robust solution since the SCSIport miniport solution may have unnecessary limitations and less flexibility.

In particular, the iSCSI port driver may effectively consolidate the SCSIport driver and a miniport driver into one driver. This helps avoid unnecessary operating system interaction and helps gain some performance boost and flexibility since the driver can then handle I/Os and queues in a manner tailored for iSCSI needs.

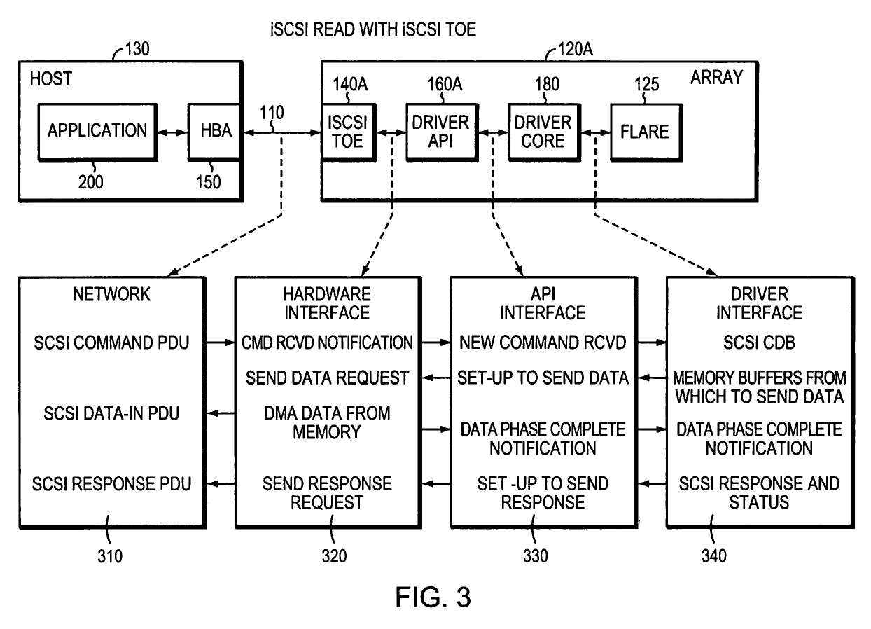

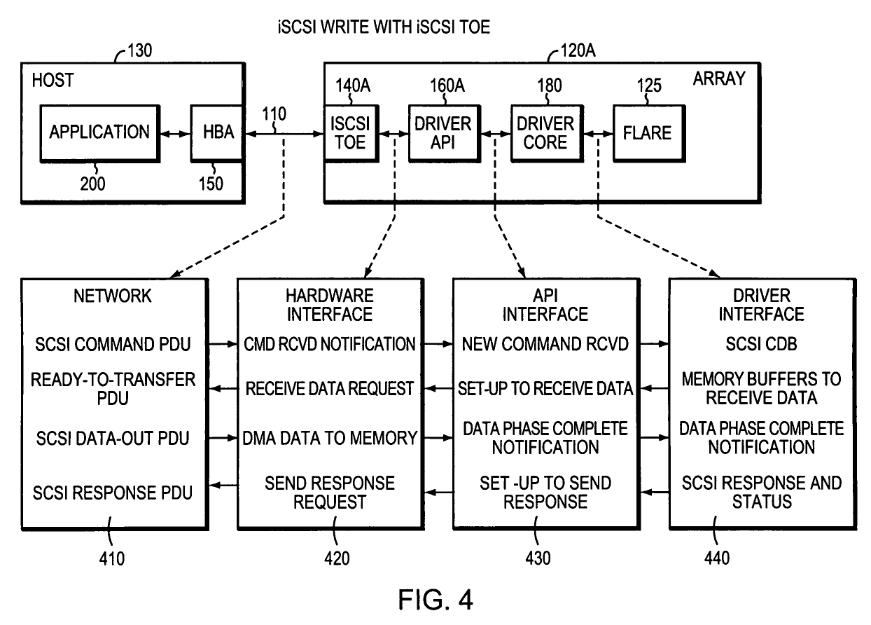

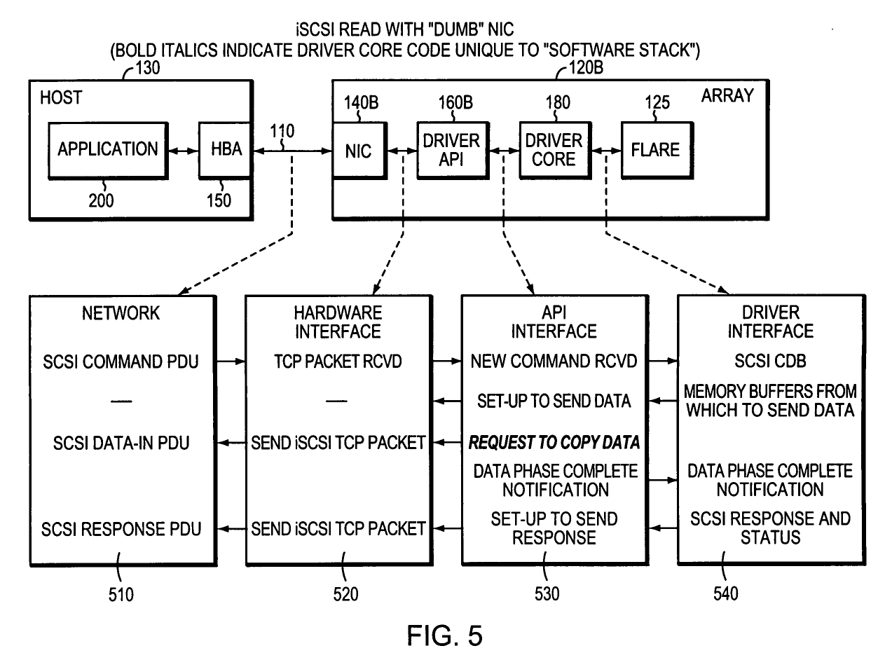

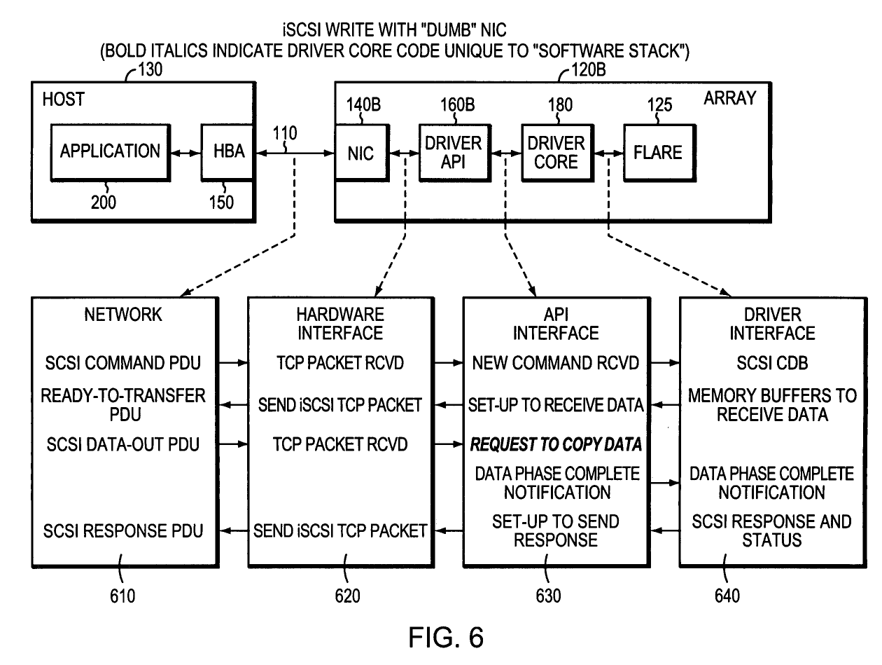

FIGS. 3-6 illustrate examples of iSCSI communications flow between the host and the server (array) and among components of the array. FIGS. 3-4 illustrate examples of such flow in the case of an array 120A that has an iSCSI TOE device 140A (e.g., a 4010 iSCSI controller) and a corresponding API 160A. FIGS. 5-6 illustrate examples of such flow in the case of an array 120B that has a standard network interface card 140B (e.g., 3COM 3C996B) and a corresponding API 160B. In all other respects, including with respect to core 180, and array communication with core 180, arrays 120A, 120B are the same. FIGS. 3-6 show that host 130 has an application (server functionality) 200 communicating with adapter (HBA) 150 to perform iSCSI read and write operations that reach and drive array operating system software (“Flare”) 125.

For the read operation illustrated in FIG. 3, block 310 illustrates communication between host adapter 150 and array adapter 140A, block 320 illustrates communication between adapter 140A and API 160A, block 330 illustrates communication between API 160A and core 180, and block 340 illustrates communication between core 180 and Flare 125.

For the write operation illustrated in FIG. 4, block 410 illustrates communication between host adapter 150 and array adapter 140A, block 420 illustrates communication between adapter 140A and API 160A, block 430 illustrates communication between API 160A and core 180, and block 440 illustrates communication between core 180 and Flare 125.

For the read operation illustrated in FIG. 5, block 510 illustrates communication between host adapter 150 and array adapter 140B, block 520 illustrates communication between adapter 140B and API 160B, block 530 illustrates communication between API 160B and core 180, and block 540 illustrates communication between core 180 and Flare 125.

For the write operation illustrated in FIG. 6, block 610 illustrates communication between host adapter 150 and array adapter 140B, block 620 illustrates communication between adapter 140B and API 160B, block 630 illustrates communication between API 160B and core 180, and block 640 illustrates communication between core 180 and Flare 125.

As illustrated in FIG. 3, host 130 and array 120A perform an iSCSI read operation in which application 200 retrieves data provided by Flare 125. Adapter 150 sends a SCSI command PDU over the network to iSCSI TOE adapter 140A, which sends a command received message to API 160A. A new command received message is sent by API 160A to core 180, which sends the SCSI CDB of the PDU to Flare 125. Memory buffers from which to send data are allocated by Flare 125 which notifies the core. The core notifies the API which issues a send data request to the adapter. The adapter retrieves data from the buffers using DMA, sends a SCSI Data-In PDU to adapter 150, and causes a data phase complete notification to be sent to Flare via the API and the core. In response, Flare issues SCSI Response and Status which results in a SCSI Response PDU back to the host, indicating successful completion of the command.

As illustrated in FIG. 4, host 130 and array 120A perform an iSCSI write operation in which application 200 sends data for storage by Flare 125. Adapter 150 sends a SCSI command PDU over the network to iSCSI TOE adapter 140A, which sends a command received message to API 160A. A new command received message is sent by API 160A to core 180, which sends the SCSI CDB of the PDU to Flare 125. Memory buffers in which to receive data are allocated by Flare 125 which notifies the core. The core notifies the API which issues a ready to transfer PDU to the adapter. The ready to transfer PDU is a permission to the host to transfer at least a portion of the data associated with the command. The host responds to a ready to transfer PDU by sending out one or more data-out PDUs containing the data requested. Adapter 140A transfers the data to the buffers using DMA and causes a data phase complete notification to be sent to Flare via the API and the core. In response, Flare issues SCSI Response and Status which results in a SCSI Response PDU back to the host, indicating successful completion of the command.

As illustrated in FIG. 5, host 130 and array 120B perform an iSCSI read operation in which application 200 retrieves data provided by Flare 125. Adapter 150 sends a SCSI command PDU over the network to NIC adapter 140B, which sends a TCP packet received message to API 160B. A new command received message is sent by API 160B to core 180, which sends the SCSI CDB of the PDU to Flare 125. Memory buffers from which to send data are allocated by Flare 125 which notifies the core. The core notifies the API. The adapter retrieves data from the buffers, sends an iSCSI Data-In PDU to adapter 150, and causes a data phase complete notification to be sent to Flare via the API and the core. In response, Flare issues SCSI Response and Status which results in a SCSI Response PDU back to the host, indicating successful completion of the command.

As illustrated in FIG. 6, host 130 and array 120B perform an iSCSI write operation in which application 200 sends data for storage by Flare 125. Adapter 150 sends a SCSI command PDU over the network to adapter 140B, which sends a TCP packet received message to API 160B. A new command received message is sent by API 160B to core 180, which sends the SCSI CDB of the PDU to Flare 125. Memory buffers in which to receive data are allocated by Flare 125 which notifies the core. The core notifies the API which directs the adapter to send a ready to transfer PDU to the host. The ready to transfer PDU is a permission to the host to transfer at least a portion of the data associated with the command. The host responds to a ready to transfer PDU by sending out one or more data-out PDUs containing the data requested. Adapter 140B transfers the data to the buffers and causes a data phase complete notification to be sent to Flare via the API and the core. In response, Flare issues SCSI Response and Status which results in a SCSI Response PDU back to the host, indicating successful completion of the command.

For the read operation illustrated in FIG. 3 block 310 illustrates communication between host adapter 150 and array adapter 140A, block 320 illustrates communication between adapter 140A and API 160A, block 330 illustrates communication between API 160A and core 180, and block 340 illustrates communication between core 180 and Flare 125.

As shown in FIGS. 3 and 5, the read operations involving alternately the iSCSI TOE adapter and the standard NIC adapter have identical blocks 310 and 510 and identical blocks 340 and 540. Blocks 320 and 520 are different, and blocks 330 and 530 are nearly identical. This illustrates that for a read operation using the same core with different adapters, the only substantial difference in communication is between the API and the adapter.

Similarly, as shown in FIGS. 4 and 6, the write operations involving alternately the iSCSI TOE adapter and the standard NIC adapter have identical blocks 410 and 610 and identical blocks 440 and 640. Blocks 420 and 620 are different, and blocks 430 and 630 are nearly identical. This illustrates that for a write operation using the same core with different adapters, the only substantial difference in communication is between the API and the adapter.

Accordingly, given that the API is a simple piece of software relative to the core, replacing or rewriting the API is all that is needed to allow use of a different adapter, which is a much simpler task than rewriting the core, for example.

Other embodiments are within the scope of the following claims. For example, at least some of the functionality described above may be used with another protocol, e.g., Fibre Channel. At least some of the functionality may be used on the host side and/or in an embedded or non-embedded environment.

What is claimed is:

1. A system for use in managing internet Small Computer Systems Interface (iSCSI) communications, the system comprising:
core logic having iSCSI protocol processing capability, the core logic being hardware independent for iSCSI communications; and
application programming interface (API) logic that is hardware dependent for iSCSI communications and that communicates with the core logic.

2. The system of claim 1, wherein the API logic is interchangeable with second API logic that communicates with the core logic.

3. The system of claim 1, wherein the API logic is interchangeable with second API logic that is hardware dependent.

4. The system of claim 1, wherein the API logic provides an interface to a hardware device that has no iSCSI offload capability.

5. The system of claim 1, wherein the API logic provides an interface to a hardware device that has iSCSI offload capability.

6. The system of claim 1, wherein the API logic provides an interface to a network interface card.

7. The system of claim 1, wherein a miniport driver includes the core logic and the API logic.

8. The system of claim 1, wherein a port driver includes the core logic and the API logic.

9. The system of claim 1, wherein a port driver includes the core logic and an operating system API.

10. The system of claim 1, wherein the core logic and the API logic provide functionality for a full iSCSI with TOE offload system.

11. The system of claim 1, wherein the core logic and the API logic provide functionality for a partial iSCSI hybrid with TOE offload system.

12. The system of claim 1, wherein the core logic and the API logic provide functionality for a no offload Microsoft TCP Chimney iSCSI system.

13. A method for use in managing internet Small Computer Systems Interface (iSCSI) communications, the method comprising:
providing core logic having iSCSI protocol processing capability, the core logic being hardware independent for iSCSI communications; and
providing application programming interface (API) logic that is hardware dependent for iSCSI communications and that communicates with the core logic.

14. The method of claim 13, wherein the API logic is interchangeable with second API logic that communicates with the core logic.

15. The method of claim 13, wherein the API logic is interchangeable with second API logic that is hardware dependent.

16. The method of claim 13, wherein the API logic provides an interface to a hardware device that has no iSCSI offload capability.

17. The method of claim 13, wherein the API logic provides an interface to a hardware device that has iSCSI offload capability.

18. The method of claim 13, wherein the API logic provides an interface to a network interface card.

19. The method of claim 13, wherein a miniport driver includes the core logic and the API logic.

20. A system for use in managing internet Small Computer Systems Interface (iSCSI) communications, the system comprising:
a data storage system having a disk drive array;
core logic having iSCSI protocol processing capability, the core logic being hardware independent for iSCSI communications with the disk drive array; and
application programming interface (API) logic that is hardware dependent for iSCSI communications and that communicates between the core logic and a network interface in the data storage system.
